(19) United States
(12) Patent Application Publication
(10) Pub. No.: US 2003/0023575 A1
(43) Pub. Date: Jan. 30, 2003

(54) System and method of automatic object classification by tournament strategy

(76) Inventors: Vladimir Shlain, Haifa (IL); Andrew Gleibman, Yokneam-Illit (IL)

Correspondence Address: DANIEL J SWIRSKY, PO BOX 2345, BEIT SHEMESH, 99544, IL

(21) Appl. No.: 10/026,886

(22) Filed: Dec. 27, 2001

Related U.S. Application Data
(60) Provisional application No. 60/283,635, filed on Apr. 16, 2001.

(51) Int. Cl. G06N 7/02

(52) U.S. Cl. 706/52

(57) ABSTRACT

A system for automatic object classification including means for applying a plurality of binary rules to an object, where any of the binary rules is operative to classify the object to one of a pair of classes, and means for determining to which of the classes the object is classified the greatest number of times subsequent to the application of the binary rules.

### CROSS-REFERENCE TO RELATED APPLICATIONS

This application claims the benefit of U.S. Provisional Patent Application Ser. No. 60/283,635, filed Apr. 16, 2001, entitled “Device and Method for General Classification of Objects Based on Selection Procedure Applied to Object Pairs,” and incorporated herein by reference in its entirety.

### FIELD OF THE INVENTION

The present invention relates to automatic classification of objects in general, and more particularly to automatic defect classification.

### BACKGROUND OF THE INVENTION

Automatic object classification is an increasingly important aspect of many industrial systems. For instance, automatic defect classification (ADC) is important aspect of semiconductor production. In conventional classification systems, classification rules are derived from a learning set of reference objects (e.g. defect images in ADC) and then applied in a production environment.

One of the most difficult and important stages in object classification is choosing an optimal set of formal features to form a feature space. The feature space should not only describe the objects of classification, but it should also relate to those object properties which best discriminate objects between different classes. Moreover, feature space selection may impact the balance between precision and generality, known to be a difficult aspect of any pattern recognition problem, as it has been shown that greater generalization may be achieved with simple rules containing a relatively small number of features, but at the expense of precision when defining rules for the learning set.

### SUMMARY OF THE INVENTION

The present invention provides a system and method of automatic object classification that overcomes disadvantages of the prior art. A novel technique for the automatic generation and application of object classification rules is described. A binary rule is defined for every pair of different defined classes Cᵢ,Cⱼ, where ij=1,2, . . . ,n; i<j; and where n is the number of defined classes, resulting in n*(n-1)/2 binary rules for n classes. A binary rule for classes Cᵢ and Cⱼ is generated in such a way that it discriminates between these classes only. Thus, when relating a binary rule to pair of classes Cᵢ, Cⱼ, an object O is classified either as belonging to class Cᵢ or as belonging to class Cⱼ. A tournament strategy of classification is then employed where for every pair of classes a winning class is found to which the object most likely belongs. The class which wins the most times then becomes the ultimate winner and thus the class among all other classes to which the object most likely belongs.

For specific types of binary rules, such as where a fuzzy-logic calculation mechanism is used, a binary rule for class pair (Cᵢ, Cⱼ) may be represented in the form of two fuzzy classification rules Rᵢⱼ and Rⱼᵢ. Thus, for every object O, values Rᵢⱼ(O) and Rⱼᵢ(O) may characterize a fuzzy degree of belonging of object O to classes Cᵢ and Cⱼ respectively. Thus, when relating a pair of rules Rᵢⱼ, Rⱼᵢ to pair of classes Cᵢ, Cⱼ, object O will be classified either as belonging to class Cᵢ (if Rᵢⱼ(O)>Rⱼᵢ(O)), or as belonging to class Cⱼ (if Rⱼᵢ(O)>Rᵢⱼ(O)).

In one aspect of the present invention a system for automatic object classification is provided including means for applying a plurality of binary rules to an object, where any of the binary rules is operative to classify the object to one of a pair of classes, and means for determining to which of the classes the object is classified the greatest number of times subsequent to the application of the binary rules.

In another aspect of the present invention the system further includes means for automatically generating the binary rules.

In another aspect of the present invention the system further includes a learning set having a plurality of the objects, where each of the objects in the learning set is pre-classified as belonging to one of the classes, and where the means for automatically generating is operative to generate the binary rules using the learning set.

In another aspect of the present invention the means for automatically generating is operative to generate using supervised learning.

In another aspect of the present invention each of the binary rules includes a first part and a second part, the means for determining is operative to calculate using the first part a degree of belonging of the object to one of the classes in the class pair, the means for determining is operative to calculate using the second part a degree of belonging of the object to the other of the classes in the class pair, and the means for applying is operative to select one of the classes in the class pairs to which the degree of belonging of the object is greater.

In another aspect of the present invention each of the parts includes at least one fuzzy logic formula including at least one named predicate related to a numerical characteristic of one of the objects, and where the means for determining is operative to calculate the degrees of belonging using the fuzzy-logic formulae.

In another aspect of the present invention the objects are images.

In another aspect of the present invention the objects are semiconductor defect images and where the classes describe defect classes for application in semiconductor production.

In another aspect of the present invention a method is provided for automatic object classification including applying a plurality of binary rules to an object, where any of the binary rules is operative to classify the object to one of a pair of a plurality of classes, and determining to which of the classes the object is classified the greatest number of times subsequent to the application of the binary rules.

In another aspect of the present invention the method further includes pre-classifying a plurality of objects in a learning set as belonging to one of the classes, and automatically generating the binary rules using the learning set, where any of the binary rules of any of the pairs of classes is generated using any of the objects in the learning set that are pre-classified as belonging to the pair of classes.

In another aspect of the present invention the automatically generating step includes generating using supervised learning.

In another aspect of the present invention the determining step includes calculating a degree of belonging of the object to one of the classes in the class pair using a first part of each of the binary rules, the determining step includes calculating a degree of belonging of the object to the other of the classes in the class pair using a second part of each of the binary rules, and the applying step includes selecting one of the classes in the class pairs to which the degree of belonging of the object is greater.

In another aspect of the present invention the determining step includes calculating the degrees of belonging using a fuzzy-logic formula included in each of the parts and including at least one named predicate related to a numerical characteristic of one of the objects.

The disclosures of all patents, patent applications, and other publications mentioned in this specification and of the patents, patent applications, and other publications cited therein are hereby incorporated by reference in their entirety.

### BRIEF DESCRIPTION OF THE DRAWINGS

The present invention will be understood and appreciated more fully from the following detailed description taken in conjunction with the appended drawings in which:

FIG. 1A is a simplified block flow illustration of a supervised method of generating classification rules in an object classification system, operative in accordance with a preferred embodiment of the present invention;

FIG. 1B is a simplified block diagram of interaction between a user and system components for generating classification rules in an object classification system, operative in accordance with a preferred embodiment of the present invention;

FIG. 1C is a simplified block diagram of interaction between a user and system components for applying generated classification rules, operative in accordance with a preferred embodiment of the present invention;

FIG. 2 is a simplified flowchart illustration of a method of generating tournament classification rules in an object classification system, operative in accordance with a preferred embodiment of the present invention; and

FIG. 3 is a simplified flowchart illustration of a method of applying tournament classification rules in an object classification system, operative in accordance with a preferred embodiment of the present invention.

### GLOSSARY OF TERMS

The following terms are used throughout the specification and claims and are defined as follows:

AOCS (Automatic Object Classification System): a system for describing classes of objects (e.g., microchip layer defect images) and automatically classifying similar objects.

Object: A named unique entity (e.g., a microchip defect image) that can be analyzed according to specific features.

Class: A set of objects that are related to a unique class name, provided by the user.

Classification: The process and result of manually and/or automatically providing class names to groups of objects.

Learning set: A set of objects, typically manually classified by a user and applied for building rules for automatic classification of objects.

Feature: A named real function of an object.

Predicate: A named real function of an object, which has values belonging to interval [0,1].

Crisp predicate: An expression in the form f>n or f<n, where f is name of a feature (for which normalization is not defined), and n is a real number. Like an ordinary predicate, a crisp predicate defines numerical function of objects as follows:

If crisp predicate p is of the form (f>n) and f(O)>n then p(O)=1;

If crisp predicate p is of the form (f>n) and f(O)<n then p(O)=0;

If crisp predicate p is of the form (f<n) and f(O)>n then p(O)=0;

If crisp predicate p is of the form (f<n) and f(O)<n then p(O)=1;

where 0 is an object.

Examples of Crisp predicates include:

Dimension >50

where Dimension is a feature name.

Transformation of features into predicates: The process of forming a predicate from a feature. This can be done in either of the following ways:

1) By applying a special function;

2) By applying a statistical normalization.

Modifier: An expression such as Somewhat, Not, Not Somewhat, More-or-Less, Not More-or-Less.

Predicate with modifier: An expression in the form <Modifier> <Predicate>, defined for non-crisp predicates only. For every non-crisp predicate P, modifiers change the function of the predicate. For example:

Not P(O)=1−P(O);

Somewhat P(O)=sqrt(P(O));

where O is an object. Other functions may be applied as operators for implementation of modifiers.

Or-predicate: An expression in the form P₁|P₂| . . . |Pₙ, where P₁,P₂, . . . , Pₙ are predicates which may contain modifiers or be crisp predicates, and n is a natural number. An or-predicate defines a real function of objects. For example: Let predicate P be an Or-predicate (P₁|P₂| . . . Pₙ). For every object O, P(O)=max((P₁(O),P₂(O), . . . , Pₙ(O)).

And-predicate: An expression in the form P₁&P₂& . . . &Pₙ, where P₁,P₂, . . . , Pₙ are predicates, which may contain modifiers or be crisp predicates, or Or-predicates, and n is a natural number. An and-predicate defines a real function of objects. For example: Let predicate P be an And-predicate (P₁&P₂& . . . &Pₙ). For every object O, P(O)=min((P₁(O),P₂(O), . . . , Pₙ(O)).

Rule: A predicate, which may contain modifiers or be crisp predicate, or-predicate, or and-predicate. For a rule R and an object O, a rule value is designated as R(O). Rule value R(O) characterizes the degree of belonging of an object 0 to an object class as defined by rule R.

Examples of rules:

1) A simple rule containing one predicate:

R₁=Circular

2) A rule formed from an and-predicates:

R₂=Black & Not Circular & (Dimension>50). Here Black and Circular are predicate names, Dimension is a feature name, and Dimension>50 is a crisp predicate.

3) A rule which contains an or-predicate:

R₃ =Circular & (Black|Dimension>50). Here Circular and Black are predicate names, and (Black|Dimension>50) is an or-predicate.

Degree of belonging: A numerical value (e.g., between 0 and 1), which characterizes a fuzzy value of classification of an object O in a class C.

Types of classification results: A characterization of a degree of belonging, for example:

Belonging to class Cᵢ, Unknown, Cannot decide.

Belonging to class Cᵢ: A classification result for object O if:

a) Its maximal degree of belonging for object O relates it to Cᵢ.

b) Its degree of belonging is greater than a certain threshold.

c) The difference between its degree of belonging and the maximal degree for other classes is greater than a certain threshold.

Unknown: A classification result for object O if its maximal degree of belonging to defined classes is less than certain threshold.

Cannot decide: A classification result for object O if:

a) Its maximal degree of belonging is greater than certain threshold;

b) The difference between its degree of belonging and the maximal degree for other classes is less than certain threshold.

Error function h(R,C1,C2): The numerical characteristics of errors which arise when applying rule R for discrimination between class C1 and class C2 in a given learning set. An error function may be calculated as follows:

h(R,C1,C2)=n11/(n11+n12)+n22/(n22+n21),

where

n11=number of objects O, classified as class C1 by the user and as class C1 by AOCS;

n12=number of objects O, classified as class C1 by the user and as class C2 by AOCS;

n21=number of objects O, classified as class C2 by the user and as class C1 by AOCS;

n22=number of objects O, classified as class C2 by the user and as class C2 by AOCS.

Note: Class C2 also may represent all objects not belonging to class C1.

Winning strategy of classification. Given two or more rules R₁, R₂, . . . , describing classes C₁, C₂, . . . correspondingly, an object O is classified as belonging to the class for which its degree of belonging (i.e. related rule value) is maximal. The corresponding class and rule are called the winning class and rule.

Binary rule: A classification rule related to a pair of different classes (Cᵢ,Cⱼ) only. Given an object O, a binary rule classifies it either as belonging to Cᵢ or Cⱼ. For example, a binary rule for classes (Cᵢ,Cⱼ) consists of a rule pair (Rᵢⱼ,Rⱼᵢ), where rule Rᵢⱼ discriminates objects of class Cᵢ from class Cⱼ and rule Rⱼᵢ discriminates objects of class Cⱼ from class Cᵢ. Rules Rᵢⱼ and Rⱼᵢ may include predicates as described above, and a comparison of values Rᵢⱼ(O) and Rⱼᵢ(O) determines the class to which object O belongs according to the winning strategy of classification.

Tournament strategy of classification. Given two or more classes C1, C2, . . . Cₙ, an object O is classified in tournament fashion where, for every pair of classes, a winning class is determined as being the class which wins the most times using binary rules.

### DETAILED DESCRIPTION OF PREFERRED EMBODIMENTS

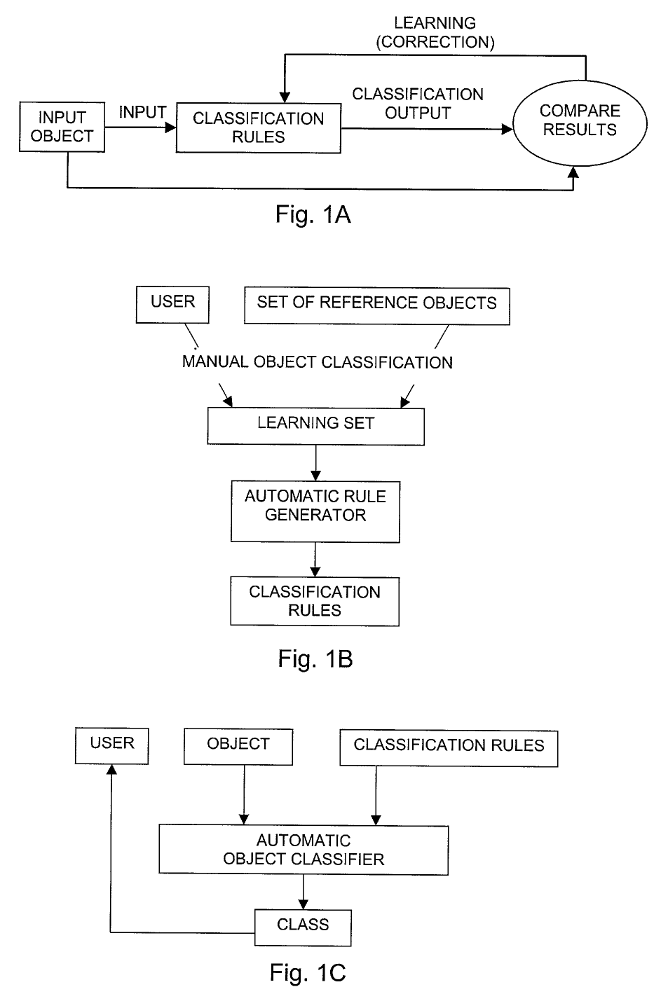

Reference is now made to FIG. 1A, which is a simplified block flow illustration of a method of generating classification rules in an automatic object classification system, operative in accordance with a preferred embodiment of the present invention. In the method of FIG. 1A supervised learning is used in which, after every learning step (i.e. after changing a classification rule) the rules are applied to objects of a learning set, and their classification results are compared with classifications of the objects that are a priori known to be correct. After this comparison, specific rule changes may be effected, in case of successful learning, or prevented in consideration of alternative rule changes. Evaluation of success or failure may be performed with respect to the number of classification errors for all objects in the learning set.

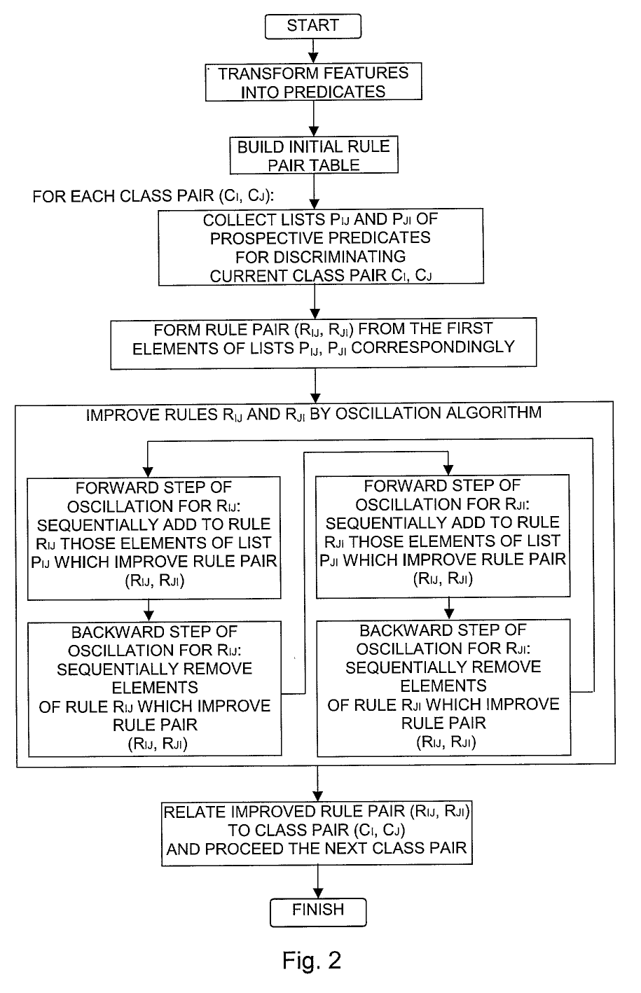

Reference is now made to FIG. 1B, which is a simplified block diagram of a method of interaction between a user and system components for generating classification rules in an object classification system, operative in accordance with a preferred embodiment of the present invention. In FIG. 1B a user provides, typically manually, a priori correct class names for reference objects and thus creates a learning set. The learning set is then used for creation of classification rules according to method of FIG. 1A and/or FIG. 2, described in greater detail hereinbelow.

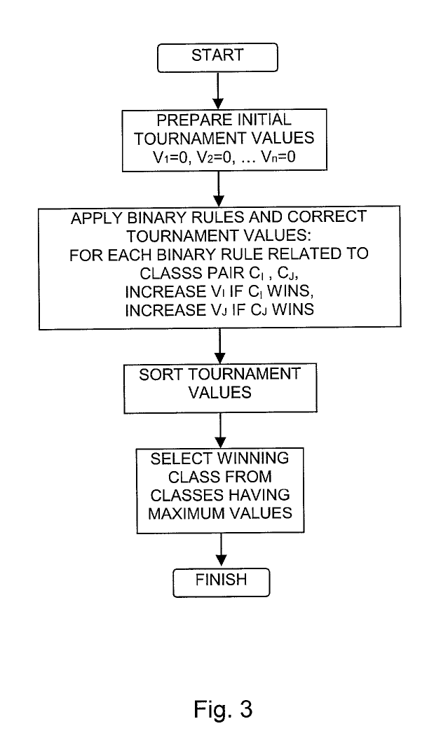

Reference is now made to FIG. 1C, which is a simplified block diagram of a method of interaction between a user and system components for application of generated classification rules operative in accordance with a preferred embodiment of the present invention. In FIG. 1C a user obtains the classification of an object. Classification is carried out using classification rules obtained according to the method of FIG. 1B. The automatic object classifier operates according to method of FIG. 3, described in greater detail hereinbelow.

Reference is now made to FIG. 2, which is a simplified flowchart illustration of a method of supervised generation of tournament classification rules in an automatic object classification system, operative in accordance with a preferred embodiment of the present invention. In a tournament classification system a binary rule is generated for every pair of different defined classes, where a binary rule for classes Cᵢ, Cⱼ may include a pair of rules, Rᵢⱼ and Rⱼᵢ. When relating a pair of rules Rᵢⱼ, Rⱼᵢ to classes Cᵢ, Cⱼ, an object O will be classified as belonging to class Cⱼ if Rᵢⱼ(O)>Rⱼᵢ(O), and as belonging to class Cᵢ if Rᵢⱼ(O)<Rⱼᵢ(O).

In the method of FIG. 2 n defect classes are defined with each class C, (where 1≦i≦n) having n−1 rules Rᵢ₁, Rᵢ₂, . . . , R_{i,i-1}, R_{i,i+1}, . . . , Rᵢₙ. The role of every such rule Rᵢⱼ is to discriminate objects of class Cᵢ from objects of class Cⱼ. For all pairs (Cᵢ, Cⱼ) of defined classes the corresponding rule pairs (Rᵢⱼ, Rⱼᵢ) are created as follows:

1) Transform features into predicates.

2) Build initial rule pair table.

3) Improve rule pairs.

Step 1, Transformation of features into predicates, is described hereinabove. Steps 2 and 3 are now described in greater detail.

2) Build initial rule pair table. The rules may be organized in a table as is shown in Table A below.

TABLE A

| | C₁ | C₂ | C₃ | . . . | Cₙ |
|---|---|---|---|---|---|
| C₁ | — | R₂₁ | R₃₁ | . . . | Rₙ₁ |
| C₂ | R₁₂ | — | R₃₂ | . . . | Rₙ₂ |
| C₃ | R₁₃ | R₂₃ | — | . . . | Rₙ₃ |
| . . . | . . . | . . . | . . . | . . . | . . . |
| Cₙ | R₁ₙ | R₂ₙ | R₃ₙ | . . . | — |

In Table A every box related to class Cᵢ is populated by copies of a rule R(Cᵢ) which may be obtained by conventional fuzzy-logic methods based on the winning strategy of classification. Thus, Rᵢ₁=Rᵢ₂= . . . =Rᵢₙ=R(Cᵢ); i=1,2, . . . , n. Rules Rᵢᵢ in the diagonal boxes are made empty. Alternatively, all boxes of Table A may be initially made empty. In this case, all initial rules Rᵢⱼ are considered to be empty. Non-empty initial rules may help in avoiding local minima of the error function applied for improvement of rule pairs.

3) Improve rule pairs. For every pair of defined classes (Cᵢ, Cⱼ), where i>j, the corresponding pair of rules Rᵢⱼ and Rⱼᵢ may be improved. Arrays Pᵢⱼ and Pⱼᵢ of prospective predicates for inclusion into rules Rᵢⱼ and Rⱼᵢ are formed as follows. For every defined predicate p (with or without a modifier), average predicate values Aₚᵢ and Aₚⱼ may be calculated where Aₚᵢ is the average value of p for objects of class Cᵢ and Aₚⱼ is the average value of p for objects of class Cⱼ. It may be seen that predicates with small average values are not desirable as prospective predicates for being and-predicates in rules since a) the minimum value of all and-predicates forms the rule value and b) for rule improvement the greatest possible rule values are sought. Therefore, a threshold constant Tₚ may be defined such that only predicates with an average value grater than Tₚ are included into the arrays Pᵢⱼ and Pⱼᵢ. Typically a value of Tₚ=0.6 is believed to be suitable for filtering out predicates with small average values. Thus, for every predicate p, if Aₚᵢ>Tₚ then p is included into array Pᵢⱼ, and if Aₚⱼ>Tₚ, then p is included into array Pⱼᵢ. A predicate may also be considered as more prospective for inclusion where the predicate has a larger difference of average values for classes Cᵢ and Cⱼ. A value Tₚᵢⱼ which characterizes the power of every predicate p for discriminating classes Cᵢ and Cⱼ may be then calculated by conventional statistical methods.

Both arrays Pᵢⱼ and Pⱼᵢ may then be sorted by descending of value Tₚᵢⱼ. A constant K may be defined such that only the first K elements of arrays Pᵢⱼ and Pⱼᵢ are kept, and all other elements removed. The value of K is preferably set in accordance with effectiveness and efficiency considerations. Typically, a value of K=20 is believed to provide satisfactory results and may be increased for achieving still better classification at the expense of rule generation time.

Once arrays Pᵢⱼ and Pⱼᵢ have been constructed, the rules Rᵢⱼ and Rⱼᵢ may be improved by applying an oscillation algorithm for finding optimal rule sets. Each rule pair is evaluated using the error functions h(Rᵢⱼ,Cᵢ,Cⱼ) and h(Rⱼᵢ,Cⱼ,Cᵢ) calculated using the winning strategy of classification for two classes only. The oscillation algorithm is then used in parallel for rules Rᵢⱼ and Rⱼᵢ, performing one forward and one backward step for Rᵢⱼ, and then performing the same for Rⱼᵢ, and so on. In a forward oscillation step predicates are added to the rule. Each next predicate P[I] which does not yet belong to rule R is taken from the associated array P. Rule R [symbol] P[I] is tested. If h(R [symbol] P[I])>h(R), then predicate P[I ] is added to rule R. Otherwise, proceed to element P[I+1]. This procedure is repeated up to the end of array P. In a backward oscillation step predicates are deleted from rule R. The removal of the first predicate p from rule R is attempted. If the resulting rule has a better error function, then predicate p may be removed from rule R, otherwise predicate p remains in rule R. The removal of the second predicate p from rule R is attempted, and so on, until all predicates in rule R are considered. The oscillation algorithm terminates if no change results after performing the backward oscillation step, or once a predetermined number of the oscillation steps are performed.

Once the oscillation algorithm has been applied for all rule pairs, a table may then be constructed from the optimal rule pairs Rᵢⱼ and Rⱼᵢ for every pair of different classes Cᵢ and Cⱼ.

Reference is now made to FIG. 3, which is a simplified flowchart illustration of a method of applying tournament classification rules in an object classification system, operative in accordance with a preferred embodiment of the present invention. In the method of FIG. 3 the results of the method of FIG. 2 are applied to an object using a Tournament strategy of classification. A maximum of n(n−1)/2 binary rules are applied, distinguishing between classes Cᵢ and Cⱼ, where i, j<n, and where n is number of classes defined in the learning set. Preferably, these rules are applied to objects whose expected classes are the same as those in the learning set.

In the method of FIG. 3 the following steps are performed:

1) Prepare a table of initial tournament values.

2) Apply binary rules and correct tournament values.

3) Sort the tournament values.

4) Determine the winning class for the object.

Each of these steps are now described in greater detail.

1) Prepare a table of tournament values. A table is preferably prepared as is shown in Table B below.

TABLE B

| | | | | |
|---|---|---|---|---|
| C₁ | C₂ | C₃ | . . . | Cₙ |
| V₁ | V₂ | V₃ | . . . | Vₙ |

In Table B n is the number of defined classes. Initially, all the values V₁, V₂, V₃, . . . , Vₙ are typically set to 0.

2) Apply binary rules and correct tournament values. For the object O being classified, binary rules related to class pairs (Cᵢ, Cⱼ) for all i=1,2, . . . ,n, j=1,2, . . . ,n, i<j are applied for all class pairs, preferably sequentially. After every such application Vᵢ is increased by a fixed amount, typically 1, if class Cᵢ wins, or Vⱼ is increased by the same fixed amount if class Cⱼ wins. Where the calculation results in a classification type of “cannot decide” or “unknown” Vᵢ and Vⱼ are left unchanged. If the binary rules are in the form of rule pairs (Rᵢⱼ,Rⱼᵢ) then rule values Rᵢⱼ(O) and Rⱼᵢ(O) for all i=1,2, . . . ,n, j=1,2, . . . ,n, i<j are calculated for all rule pairs. After every step in this calculation Vᵢ is increased by a fixed amount, typically 1, if Rᵢⱼ(O)>Rⱼᵢ(O), or Vᵢ is increased by the same fixed amount if Rⱼᵢ(O)>Rᵢⱼ(O).

3) Sort the tournament values. The resulting tournament values [V₁, V₂, . . . , Vₙ] are sorted in descending order. An analysis of the three maximal values Vᵢ, Vⱼ, Vₖ is then performed as follows.

4) Determine the winning class for the classified object. For classes Cᵢ, Cⱼ, and Cₖ:

a) If Vᵢ>Vⱼ=Vₖ (i.e. exactly one maximum value exists), then Cᵢ is the winning class.

b) If Vᵢ=Vⱼ>Vₖ (i.e. exactly two maximum values Vᵢ and Vⱼ exist), then:

Cᵢ is the winning class if Rᵢⱼ(O)>Rⱼᵢ(O);

Cⱼ is the winning class if Rⱼᵢ(O)>Rᵢⱼ(O);

c) If Vᵢ=Vⱼ=Vₖ (i.e. more than two maximum values exist), then no winning class is selected.

The present invention is thus advantageous over the prior art in that a simple and effective feature space is provided for every binary rule, thus ensuring better utilization of a priori information and better generalization of the rules in a testing environment. The present invention also provides more precise classification of the objects. The evaluation of a predicate which separates two homogeneous classes only as in the present invention, is simpler than the evaluation of a predicate which separates a given class from all other classes as in traditional automatic object classification systems. Design and application of new predicates is also simplified for the user who needs only to consider two classes at a time with the present invention, rather than approach design and application as a multi-class problem.

It is appreciated that one or more of the steps of any of the methods described herein may be omitted or carried out in a different order than that shown, without departing from the true spirit and scope of the invention.

While the methods and apparatus disclosed herein may or may not have been described with reference to specific hardware or software, it is appreciated that the methods and apparatus described herein may be readily implemented in hardware or software using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A system for automatic object classification comprising:
means for applying a plurality of binary rules to an object, wherein any of said binary rules is operative to classify said object to one of a pair of classes; and
means for determining to which of said classes said object is classified the greatest number of times subsequent to the application of said binary rules.

2. A system according to claim 1 and further comprising means for automatically generating said binary rules.

3. A system according to claim 2 and further comprising a learning set having a plurality of said objects, wherein each of said objects in said learning set is pre-classified as belonging to one of said classes, and wherein said means for automatically generating is operative to generate said binary rules using said learning set.

4. A system according to claim 2 wherein said means for automatically generating is operative to generate using supervised learning.

5. A system according to claim 1 wherein:
each of said binary rules includes a first part and a second part,
said means for determining is operative to calculate using said first part a degree of belonging of said object to one of said classes in said class pair,
said means for determining is operative to calculate using said second part a degree of belonging of said object to the other of said classes in said class pair, and
said means for applying is operative to select one of said classes in said class pairs to which said degree of belonging of said object is greater.

6. A system according to claim 5 wherein each of said parts comprises at least one fuzzy logic formula including at least one named predicate related to a numerical characteristic of one of said objects, and wherein said means for determining is operative to calculate said degrees of belonging using said fuzzy-logic formulae.

7. A system according to claim 1 wherein said objects are images.

8. A system according to claim 1 wherein said objects are semiconductor defect images and wherein said classes describe defect classes for application in semiconductor production.

9. A method for automatic object classification comprising:
applying a plurality of binary rules to an object, wherein any of said binary rules is operative to classify said object to one of a pair of a plurality of classes; and
determining to which of said classes said object is classified the greatest number of times subsequent to the application of said binary rules.

10. A method according to claim 9 and further comprising:
pre-classifying a plurality of objects in a learning set as belonging to one of said classes; and
automatically generating said binary rules using said learning set, wherein any of said binary rules of any of said pairs of classes is generated using any of said objects in said learning set that are pre-classified as belonging to said pair of classes.

11. A method according to claim 10 wherein said automatically generating step comprises generating using supervised learning.

12. A method according to claim 9 wherein:
said determining step comprises calculating a degree of belonging of said object to one of said classes in said class pair using a first part of each of said binary rules,
said determining step comprises calculating a degree of belonging of said object to the other of said classes in said class pair using a second part of each of said binary rules, and
said applying step comprises selecting one of said classes in said class pairs to which said degree of belonging of said object is greater.

13. A method according to claim 12 wherein said determining step comprises calculating said degrees of belonging using a fuzzy-logic formula included in each of said parts and including at least one named predicate related to a numerical characteristic of one of said objects.
